(19) United States
(12) Patent Application Publication
(10) Pub. No.: US 2002/0094111 A1
(43) Pub. Date: Jul. 18, 2002

(54) Access control method and apparatus

(76) Inventors: Daniel R. Puchek, (US); Tianning Xu, (US); David M. Tumey, (US)

Correspondence Address: NIXON PEABODY, LLP, 8180 GREENSBORO DRIVE, SUITE 800, MCLEAN, VA, 22102, US

(21) Appl. No.: 09/759,158

(22) Filed: Jan. 16, 2001

Related U.S. Application Data
(63) Continuation-in-part of application No. 09/574,001, filed on May 19, 2000.

(51) Int. Cl. G06K 9/00

(52) U.S. Cl. 382/115

(57) ABSTRACT

An automated access control apparatus and method. Identification data is compared with stored data to determine if a person should be granted access to an area, such as a residence. Video image data of entrances and attempted entrances is recorded and time and date stamped to permit playback in real time or at a later time for review. Playback can be accomplished over a cable television system. The apparatus can be integrated with a home security/alarm system.

### RELATED APPLICATION DATA

This application is a continuation-in-part of applicant's patent application Ser. No. 09/574,001 filed May 19, 2000 entitled DISTRIBUTED BIOMETRIC ACCESS CONTROL APPARATUS AND METHOD, and ACCESS CONTROL METHOD AND APPARATUS FOR MEMBERS AND GUESTS which is filed concurrently herein, and the disclosures of which are incorporated herein by reference.

### BACKGROUND OF THE INVENTION

1. Field of the Invention

The invention relates to automated systems for permitting authorized persons to access secured buildings or other areas while preventing such access by unauthorized persons. More particularly, the invention relates to an access control method and apparatus which identify authorized persons and permit access by the authorized persons and their approved guests while monitoring and recording access attempts.

2. Description of the Related Art

The invention relates to controlling access into a restricted area and thus the term “access”, as used herein, refers to physical entry into a building, or other restricted area. However, the restricted area can be the exterior of a building or the like and thus the invention can be applied to controlling entry into or exit out of a building or other area. There have always been situations in which it was desirable to restrict access to certain physical areas to a select person or group of people. Such restricted access has been accomplished by fences, walls, locks and other barriers. However, even the use of barriers has not prevented unauthorized access. Accordingly, it has been necessary in many instances to provide human surveillance in the form of a security guard or receptionist at an entrance to an area or through the use of video cameras or the like to transmit images to persons at a remote or centralized location. Of course, the use of personnel and video cameras can become expensive and is only as reliable as the personnel and their state of alertness at any particular time.

The complexities of modem society have only served to increase the need for access control. For example, many government agencies and contractors work on matters that are of a confidential or even “top secret” nature. In fact, most workplaces, such as offices, warehouses, and even retail stores in some instances, have a need to implement access control to prevent the theft of intellectual property and/or goods. Further, “members only” establishments, such as health clubs, country clubs, and the like, may derive revenue from membership fees and thus must restrict access to current members and approved guests. Of course, the use of personnel to monitor access adds significant financial overhead. However, particularly in members only establishments, the costs of monitoring personnel must be balanced with the loss of revenue due to access by non members or non approved guests. Therefore, many members only establishments have an employee stationed at the entrance during all hours of operation. The salary, benefits, and other costs associated with such an extra employees are significant.

The use of biometrics has been proposed as a solution to the limitations noted above. Generally, the term “biometrics” refers to the study of measurable biological characteristics, i.e. biometric parameters, of a living being. In the context of security, “biometrics” refers to techniques that rely on a unique, measurable characteristic of a living being for automatically recognizing or verifying identity. Examples of biometric parameters are facial data, retinal data, fingerprint data, speech data, and the like.

Generally, biometric systems operate in the following manner. First, a system captures a sample of at least one biometric parameter of an authorized person during an “enrollment” process. The parameters are then converted by the system into a mathematical code, i.e., data, that is stored as the biometric template representing measured biometric parameters for that person. When access is desired, a new sample of biometric parameters is taken. If one of the templates and the new sample match, the person is recognized as authorized.

Central to a biometric system is the “engine” which processes the biometric data in accordance with various algorithms or artificial neural networks. Some biometric systems use “identification” engines and some use “verification” engines. In identification systems, a new sample is presented to the biometric system and the system then attempts to find out who the sample belongs to by comparing the sample with a plurality of templates obtained through enrollment. Verification systems on the other hand perform a one-to-one process where the biometric system is seeking to verify identity. A single biometric sample is matched against a single template obtained during enrollment. If the two match, the system effectively confirms that the person actually is who he presents himself to be. The key difference between these two approaches centers on the logic addressed by the biometric system and how these fit within a given application. Identification systems decide who the person is and can check whether more than one matching biometric template exists. Accordingly, identification systems can deny access to an individual who is attempting to pass himself off with more than one identity. Verification, on the other hand only decides if the person is who he says he is. Accordingly, identification systems are more versatile and powerful. However, verification systems generally require less processing horsepower and thus are commonly used.

In typical biometric access control systems, biometric sensors are placed proximate entrances and are linked to a central computer which collects biometric “enrollment” data, i.e., templates, representing biometric parameters of authorized users collected from a central enrollment station. If the biometric parameter collected at the entrance matches a template stored in the central computer, access is granted. However, conventional biometric systems have several limitations. In particular, the sensing accuracy of biometric parameters, such as facial parameters, retinal parameters, and the like is highly dependent on the environment in which the parameters are sensed. For example, the lighting intensity, angle and color will affect sensing of biometric parameters. Accordingly, the ability to reliably match data representing parameters collected at an entrance with data of templates collected during a centralized enrollment is limited, especially when the entrance is an external entrance where the weather, season, and time of day will affect lighting significantly. Also, sensing biometric parameters, converting the parameters to data, communicating the data to a central computer, and comparing the data parameters with templates of enrollment data in the central computer is relatively time consuming, even with modern high speed computers and communication links. Accordingly, such systems present significant inconveniences to the authorized persons through improperly rejected access and time delays prior to granting access.

Further, known automated access control systems including biometric systems, are not easily adapted to residential applications because they require a powerful central computer and enrollment station that is ordinarily not practical in residential applications. Also, conventional systems do not address the need to prevent unauthorized persons from entering on the “coattails” of an authorized person, a technique referred to as “tailgating” herein. Also, known automated access control systems do not provide a video log of persons entering an area. Finally, conventional systems are not integrated with existing residential systems, such as home security alarm systems and cable television systems.

U.S. Pat. No. 5,283,644 discloses a monitoring system in which presence is detected in a protected area. Upon detecting a presence, image data is collected by a camera and collated with image data of authorized persons. If the image data does not match image data of authorized persons, the presence is reported to security through report data. This reference relates to internal surveillance and not access control. U.S. Pat. No. 5,280,266 discloses a visitor sensing device capable of being combined with a conventional intercom. When a visitor is present at a door for a specified period of time, a live image of the visitor is displayed to the occupant and an audible alarm is sounded. This reference does not relate to biometric recognition and requires that a receptionist or security person be present to review the image and converse over the intercom. However, these patents fail to overcome the deficiencies above that render it difficult to apply conventional access control in the residential environment.

### SUMMARY OF THE INVENTION

It is an object of the invention to overcome the limitations of the known systems described above.

It is another object of the invention to integrate access control with existing residential television and security systems.

It is another object of the invention to integrate access control systems into the residential environment.

It is another object of the invention to automatically control and record access to a residence.

It is another object of the invention to permit access to guests while notifying a head of household or other designated personnel.

It is another object of the invention to record data relating to guest access.

It is another object of the invention to integrate access control with existing residential television and security systems.

It is another object of the invention to minimize the inconvenience and obtrusiveness of biometric identification access control.

It is another object of the invention to minimize the effect of environmental variables in biometric identification access control.

It is another object of the invention to automatically indicate any security anomaly in an access control system.

A first aspect of the invention is an access control apparatus for selectively granting access to an area comprising a controller including a processor and memory, an access control device, and means for collecting identification and image data.

The controller is operative to compare identification data collected by said means for collecting with stored data in said memory and to operate said access control device to grant access to the area when the identification data corresponds to the stored data, and the controller is operative to record image data output by said means for collecting in said memory and to present the image data for review.

A second aspect of the invention is a method of controlling access to an area comprising the steps of comparing entrance data, which includes identification data, collected by a data collection device proximate an entrance to the area with stored data, granting access to the area when the identification data corresponds to the stored data, counting persons accessing the area, repeatedly recording image data for a predetermined period of time, and presenting the image data for review when a number of people counted during said counting step does not correspond to the number of people indicated by said entrance data.

### BRIEF DESCRIPTION OF THE DRAWING

The invention is described through a preferred embodiment and the attached drawing in which:

FIG. 1 is a block diagram of the architecture of an access control system incorporating the preferred embodiment;

FIG. 2 is a flowchart of the enrollment procedure of the preferred embodiment; and

FIG. 3 is a flowchart of the access control and reporting procedure of the preferred embodiment.

### DETAILED DESCRIPTION OF THE PREFERRED EMBODIMENT

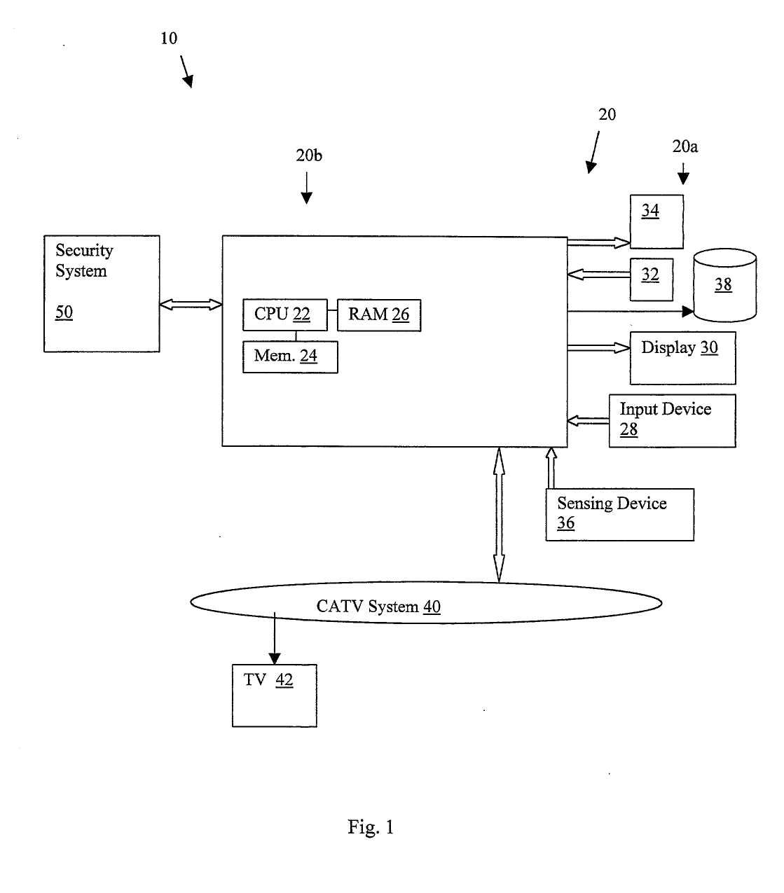

FIG. 1 illustrates a system architecture incorporating a preferred embodiment of the invention. Residential access control system 10 includes access unit 20 which can be a microprocessor based computer, such as a personal computer, a minicomputer, a programmable logic controller, or any other proprietary or nonproprietary device capable of accomplishing the processing and communication functions described below. Access unit 20 includes central processing unit (CPU) 22, memory device 24 (such as a magnetic hard drive), random access memory (RAM) 26, input device 28 (such as a keypad), display 30 (such as an LCD or LED panel), microphone 32, speaker 34, biometric parameter sensing device 36, access control device 38 (such as a lock solenoid, gate, or the like), a data bus (not illustrated) for providing communications between the various components, and the appropriate interfaces for each component (also not illustrated).

Biometric parameter sensing device 36 is a video camera for sensing facial parameters in the preferred embodiment. However, biometric parameter sensing device 36 can also include any type for sensing any appropriate parameter such as fingerprint parameter, retinal parameters, or the like. The phrase “video camera”, as used herein, refers to any device capable of sensing image parameters. Access unit 20 has a control program stored in memory device 24 which includes instructions for accomplishing the functions described below. The control program of access unit 20 also includes a biometric engine, such as that described in U.S. Pat. No. 5,386,103, the disclosure of which is incorporated herein by reference. Access unit 20 can be divided into access panel 20a (including input device 28, display 30, microphone 32, speaker 34, biometric parameter sensing device 36, and access control device 38) and controller 20b (including CPU 22, memory device 24, and RAM 26). Access panel 20a and controller 20b can be housed separately. However, the number of physical enclosures associated with access unit 20 can vary as is required by the particular application and entrance.

Access panel 20a preferably is located in close proximity to a door or other entrance of the area to which access unit 20 is applied. Typically, access panel 20a is located just outside the doorframe and controller 20b is located inside the area to prevent tampering therewith. Note that plural access units 20 can be coupled to one another over a communication link, such as a network, to share information. For example, in a building having plural entrances, one access unit 20 can be provided at each entrance. The communication link can be continuous, such as an Ethernet connection or home network, or intermittent, such as a dial-up connection over a modem.

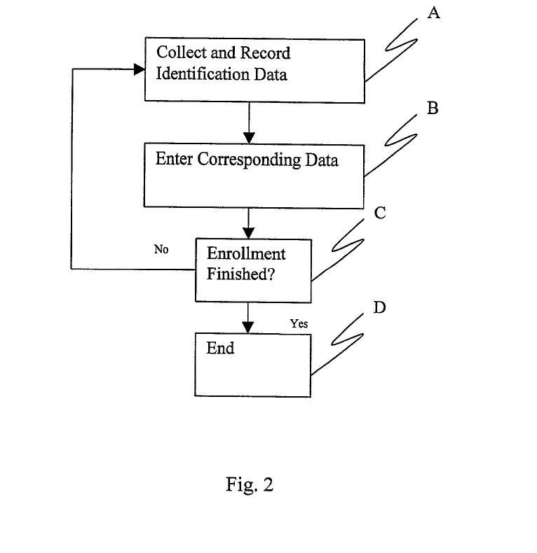

FIG. 2 illustrates an enrollment procedure of the preferred embodiment in which persons are authorized for access. For example, members of a family can be authorized for access into their house. Enrollment can be accomplished at access panel 20a. For example, the enrollment procedure can be similar to that disclosed in the copending application Ser. No. 09/574,001 the disclosure of which is incorporated herein. The preferred embodiment uses biometric parameters (such as facial parameters) for permitting or denying access. Accordingly, the enrollment procedure includes collecting facial parameter data as identification data. However, the identification data could be in any form, such as a PIN number, a coded card, a password, or the like. The enrollment procedure preferably is conducted at access panel 20a, i.e. at the entrance, to minimize the effect of environmental variables on the enrollment procedure. A person to be authorized for access to the area, such as a family member, is brought to an enrollment location, i.e. the entrance, proximate access panel 20a. Biometric facial parameters are collected by biometric parameter sensing device 36 in step A. In particular, facial image data is recorded or collected by biometric parameter sensing device 36 and converted to facial data by the biometric engine. This is accomplished by placing the person in view of biometric parameter sensing device 36 and selecting appropriate choices on input device 28, as prompted by messages on display 26, in accordance with the control program stored in memory device 24 executed by CPU 22. Data corresponding to the sensed facial parameters is then recorded in memory device 24. Using input device 38, corresponding data, such as the family member's name, access privileges (e.g. time of day, day, number of permitted guests) and the like is entered in step B and stored in memory device 24 in correspondence to the data stored in step A. While the preferred embodiment is discussed with reference to a family member, it is important to note that the invention can be used to control access by any person, such as a household employee, a real estate agent, a home improvement contractor, or the like. Therefore, it may be desirable to restrict access for some persons by the time of day, by the days of the week, for a predetermined period of time, by the prohibition of guests, or the like.

In step C, it is determined if all enrollment is finished, i.e. if the operator does not wish to enroll other persons at this time. If so, the procedure ends at step D, if not, the procedure returns to step A for collection of biometric parameter data for another person. Enrollment data, including identification data and corresponding data entered in steps A and B respectively, can optionally be downloaded to any other access units 20 over the communication link. The enrollment data can be stored in memory device 24 of access unit 20 as templates in any format, such as known database formats. Of course, the enrolment procedure can be accomplished at any time and one or more persons can be enrolled during each procedure. Also, enrollment data can be deleted or modified as needed. For example, when a household employee is terminated, it may be desirable to delete the person's template so that they will not be granted access to the facilities in the future. Alternatively, the template of a terminated employee may be left while their access privileges are revoked. In such a situation presence of the person near an entrance can be flagged as an anomaly, as described below, without granting access.

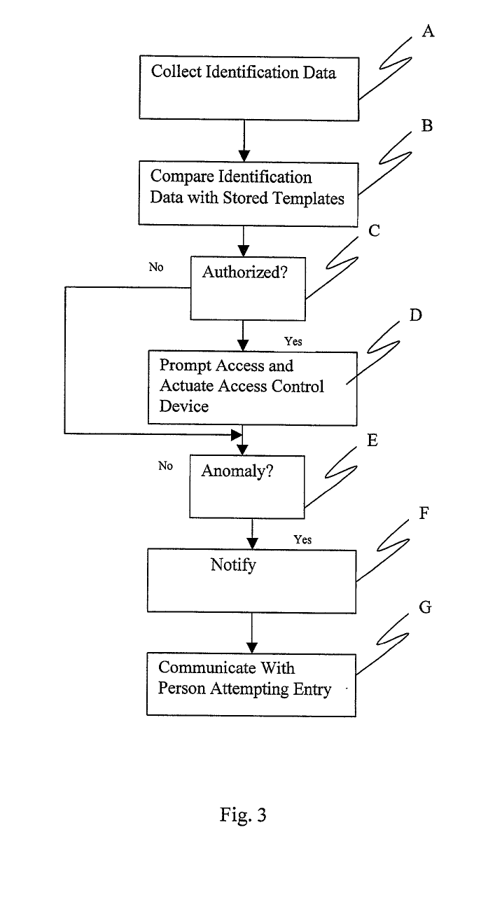

When enrollment for one or more authorized persons is finished, access unit 20 is ready to identify authorized persons and control access to the home or other area. FIG. 3 illustrates the procedure for controlling access. As a person approaches an entrance having access panel 20a, biometric parameter sensing device 36 begins to collect facial image data as identification data, i.e. to sense facial parameters, in an attempt to identify the person as an authorized person. Biometric parameter sensing device 36 can be in constant operation and can begin to sense facial parameters when a person is within a prescribed range. Alternatively, biometric parameter sensing device 36 can be turned on by the presence of the person using a proximity sensor or the like. The engine disclosed in U.S. Pat. No. 5,386,103 is capable of sensing facial parameters while the subject person is several feet away. In any event, as the person approaches access unit 20, facial parameters are sensed and facial data is collected in step A. In step B, the facial data corresponding to the sensed parameters are compared with templates stored in memory device 24 of access unit 20.

In step C, access unit 20 determines if the approaching person has been identified as a person that is authorized for access (e.g. a family member) through steps A and B. Note that, in order to be authorized for access, the person must be recognized by matching their parameters with a template and must have access privileges, as indicated by the corresponding data, that are effective at the time of entrance. An audible or visual prompt can be enunciated upon recognition of the person as authorized for access at that time and access control device 38 can be actuated to permit access in step D.

The facial recognition engine can distinguish faces and thus can act as a sensor to count people, i.e. faces, passing thereby. The passage through the entrance of a one or more guests, or a number of guests larger than a permitted number for that authorized person can be flagged as an anomaly in step E and access unit 20 can notify the appropriate person, the head of the household for example, by one or more of sounding an alarm, sending a message (by email, fax, telephone for example), or the like in step F. As noted above, biometric parameter sensing device 36 collects image data of each approaching person or persons. In the event of an anomaly such as an incorrect number of guests in this case, notification can include preventing the previous several seconds of image data to the head of household by being displayed on a monitor in the house or at another location. In substantially real time or for later review. Accordingly, images, i.e. video, of each anomaly creating approach can be viewed in step F. Further, notification can include activating an alarm or emergency dial up connection of security system 50.

In the preferred embodiment, access unit 20 is coupled to cable television (CATV) system 40 of the house and notification includes displaying the anomaly entrance video images over one or more televisions 42 in the house. In step G, the head of the household or the appropriate person viewing the anomaly entry images can communicate with the person or persons causing the anomaly through microphone 32 and speaker 34 to ascertain the person's status or to warn the person of their violation of their access privileges or otherwise review the anomaly. To accomplish this, access unit 20 can be coupled to a conventional home intercom system or network.

Various actions can be flagged as anomalies and subject to review in steps E,R, and G of the procedure illustrated in FIG. 3. For example, unauthorized persons gaining access on the coattails of authorized persons could be flagged. Each time access is granted in step D of FIG. 3, access unit 20 can count the number of persons passing through the entrance detected in step E if more than one person enters a “tailgating” anomaly is detected. Counting can be accomplished with biometric parameter collection device 36 or with any appropriate sensor, such as a photo sensor, proximity sensor, or the like. Further, an anomaly can be any situation other than the normal granting of access to an authorized person within their access parameters. An anomaly can result from the satisfaction of any predetermined criterion. For example, it may be desirable to know if a particular authorized person or persons, gains access more than a preset number of times. Also, it may be desirable to know if a previously authorized person whose access privileges have been revoked is near an entrance. Of course, an access attempt by an unauthorized user can be flagged as an anomaly. Access unit 20 is programmed in a desired manner to detect anomalies under any particular set of conditions. Note that anomalies can be handled in any way. For example, the person desiring access can be prompted to press a doorbell button, an alarm of security system 50 can be sounded, emergency services can be summoned, or any other actions or combinations thereof can be taken.

As note above, unrecognized persons approaching the entrance can be flagged automatically as an anomaly and an alarm, such as a doorbell, can be sounded. However, it may be desirable to prompt the unrecognized person to press a doorbell or button or to communicate through speaker 34 and microphone 32 with an occupant of the house. Of course, the occupant can operate access device 38 remotely upon recognizing the “unrecognized” person based on the image data, e.g. video displayed on television 42 or another monitor.

The image data can be time and date stamped and saved in memory device 24 for later review over CATV system 40, on display 30, or on another playback device, such as a personal computer. In this manner, the head of the household, or another person, can view all entrances and attempted entrances along with the time and date of each entrance. For example, if a teenage child has a curfew and/or is not permitted to bring guests into the house after a specific hour, the image data review will present verification of compliance or noncompliance with this policy whether or not the parents are at home when the child returns home. Of course, the teenage child's access privileges can be restricted to certain hours in which case the child can be denied access after the curfew or an anomaly alarm can be sounded. However, these solutions may be harsh in certain circumstances and thus the ability to review all entrances, whether an anomaly or not, is desirable.

It can be seen that the preferred embodiment provides the convenience of reliable automated access control without sacrificing the flexibility required by families and other entities. Also, the preferred embodiment processes the biometric parameters at the entrance and thus biometric identification can be accomplished very quickly. Further, when the enrollment procedure is conducted at the entrance, environmental variables are minimized. The preferred embodiment also permits flexible handling of anomalies and permits review of each entrance and attempted entrance and the conditions thereof.

There can be any number of access units. Any hardware and/or software can be used in the invention for accomplishing the functions disclosed above. The various data communication and storage can be accomplished using any appropriate formats, protocols, and media. The various disclosed features of the invention can be combined in any manner. The control program can be programmed in any programming language by one of skill in the art based on the functions disclosed herein. Any biometric or other technologies can be used for identification in the invention and any type of sensors or scanners can be used to collect the appropriate data or parameters. Identification can be accomplished through collecting of data or parameters other then biometric data or parameters. The invention can be applied to identification and/or verification systems. The access control device can be interfaced to home security and/or intercom systems through any appropriate interface such as serial, parallel, Universal Serial Bus, X-10, or the like. The access control device can be interfaced to a CATV System using standard hardware and protocols. The access control device can be any device for selectively providing access. The invention can be used to control entry into an area or exit from the area. Accordingly, the term “entrance”, as used herein, refers to a door, gate, passage, or the like through which persons can enter or leave an area.

The invention has been described through a preferred embodiment. However various modifications can be made without departing from the scope of the invention as defined by the appended claims.

What is claimed:

1. An access control apparatus for selectively granting access to an area comprising:
a controller including a processor and memory;
an access control device; and
means for collecting identification and image data;
wherein said controller is operative to compare identification data collected by said means for collecting with stored data in said memory and to operate said access control device to grant access to the area when the identification data corresponds to the stored data, and wherein said controller is operative to record image data output by said means for collecting in said memory and to present the image data for review.

2. An apparatus as recited in claim 1, wherein said means for collecting device comprises a biometric parameter collection device, said identification data includes biometric data.

3. An apparatus as recited in claim 2, wherein said biometric parameter collection device is a video camera and identification data is biometric facial data.

4. An apparatus as recited in claim 3 further comprising a monitor coupled to said controller, said controller being operative to display an image on said monitor corresponding to image data presented for display.

5. An apparatus as recited in claim 4 wherein said monitor is a television set coupled to said controller by a cable TV system.

6. An apparatus as recited in claim 4 further comprising a home security system having an alarm device coupled to said controller, said controller being operative to activate said alarm device when an anomaly is detected.

7. An apparatus as recited in claim 4, wherein said controller is operative to display the image on said monitor in a substantially real time manner.

8. An apparatus as recited in claim 1, wherein said means for collecting comprises a keypad for collecting a code as identification data and a video camera for collecting image data.

9. A method of controlling access to an area, said method comprising the steps of:
comparing entrance data, which includes identification data, collected by a data collection device proximate an entrance to the area with stored data;
granting access to the area when the identification data corresponds to the stored data;
counting persons accessing the area;
repeatedly recording image data for a predetermined period of time; and
presenting the image data for review when a number of people counted during said counting step does not correspond to the number of people indicated by said entrance data.

10. A method as recited in claim 9, wherein the identification data comprises biometric data and the entrance date includes data indicating a number of persons desiring access.

11. A method as recited in claim 10 further comprising the step of erasing image data that is not presented for review.

12. A method as recited in claim 10 further comprising the step of displaying an image corresponding to image data presented for display.

13. A method as recited in claim 12 further comprising the step of activating an alarm device when the image data is presented for display.

14. A method as recited in claim 13, wherein said display step is accomplished in a substantially real time manner.

15. A method as recited in claim 11, wherein said presenting step is accomplished if a number of persons counted in said counting step is greater than the number of persons authorized in accordance with the stored data and the identification data.

16. A method as recited in claim 11, wherein the biometric data comprises facial data.
